(19) United States
(12) Patent Application Publication
(10) Pub. No.: US 2006/0266823 A1
(43) Pub. Date: Nov. 30, 2006

(54) Authentication method and system for use in vending a restricted product or service

(76) Inventors: Selvin Passen, Fort Lauderdale, FL (US); Kevin W. Baker, Severn, MD (US); Michael E. Stone, Pinebrook, NJ (US)

Correspondence Address: JONES, TULLAR & COOPER, P.C., P.O. BOX 2266 EADS STATION, ARLINGTON, VA, 22202, US

(21) Appl. No.: 11/442,214

(22) Filed: May 30, 2006

Related U.S. Application Data
(60) Provisional application No. 60/685,497, filed on May 31, 2005.

(51) Int. Cl. G06F 7/08

(52) U.S. Cl. 235/381

(57) ABSTRACT

An identity authentication method authenticates valid purchases of restricted products or services such as alcoholic beverages from unattended vending machines. The authentication method is designed to comply with all 50 States' requirements, as the equipment includes a field-programmable age requirement verification mechanism. The process consists of two primary steps: 1) Registration, a one-time procedure where a Patron's age is verified, fingerprint enrolled and information entered into an electronic tag, as well as a central database (if applicable); and 2) Purchase, which occurs each time a product is purchased, where the Patron presents the electronic tag to a tag reader (located on the front of the vending machine), authenticates his/her Identification by placing the appropriate finger onto a fingerprint scanner (also located on the front of the vending machine), then proceeds to purchase the product via cash, credit card, or whatever other method is applicable to that particular location.

### RELATED PATENT APPLICATION INFORMATION

This application claims priority to provisional patent application No. 60/685,497, filed May 31 st, 2005, the entire disclosure of which is incorporated herein by reference.

### BACKGROUND OF THE INVENTION

1. Field of the Invention

The present invention relates to use of automated vending machines for selling products or services directly to the public. More particularly, the present invention relates to vending machines having identity authentication mechanisms to confirm the person buying a restricted product or service from a vending machine (or other automated provider) is authorized or legally permitted to make such a purchase.

2. Discussion of the Prior Art

Many products are restricted or controlled by statute or rule; for example, minors are, in many jurisdictions, prohibited from purchasing, possessing or consuming alcoholic beverages. Restricted or controlled products are therefore often sold or dispensed in a facility housing employees tasked with verifying that an individual is permitted to buy a selected restricted product. Personnel costs and facility related costs add substantially to the cost of providing such products to those customers or users who are permitted to buy. The customers are also inconvenienced, since they must go to the facility and see the person who can verify that a transaction is authorized, and so opportunities to serve those customers may be lost.

Vending machines are automated machines that can be positioned conveniently to provide a product or service to a customer upon the payment of a fee. There are many different types of vending machines selling a wide variety of products and services.

Vending machines are popular because they can be placed for customer's convenience. Vending machines are ready for business at all times of the day and night. Furthermore, vending machines can be placed in remote locations, such as marinas, train stations or hotel corridors. Unfortunately, conventional vending machines are non-discriminating and will sell a product or service to anyone who deposits the required fee. Indiscriminate vending is fine when vending unrestricted or unregulated products such as candy, chips or soda, but laws may be broken when a vending machine is stocked to sell restricted products such as beer, wine or cigarettes to individuals not legally permitted to purchase such products.

Many jurisdictions have enacted laws banning vending machines that sell regulated products, such as cigarettes, in the hope that potential abuse of these vending machines will be eliminated, and so have removed a convenience to customers, the vast majority of which are likely allowed to purchase the products being sold.

In the prior art, there have been attempts to change the design of vending machines so that the vending machines can only sell products to authorized customers. Such prior art vending machines include U.S. Pat. No. 5,722,526 to Sharrard “Dispensing Security System For A Vending Machine.” The '526 patent discloses a vending machine that validates the identity of a consumer through an identification card. The identification card is inserted into the vending machine. If the identification card indicates that the customer is of legal age, the vending machine will vend the regulated product, but any underage person possessing an otherwise “valid” identification card can use the vending machine and so the degree of verification is insufficient to adequately address the social health reasons for the ban on vending machines stocked to sell regulated products.

U.S. Pat. No. 6,711,465 to Tomassi “Vending Machine having a Biometric Verification System for Authorizing the Sales of Regulated Products” discloses a vending machine that validates the identity of a consumer through an identification card and, additionally a biometric measurement. The identification card is inserted into the vending machine, the user is prompted to place, e.g., a thumb on a thumb pad to generate biometric characteristic data, and a biometric verification step compares the biometric characteristic data to the data on the card, enabling a vending process if the data match. The Tomassi method appears not have met with widespread acceptance, however. One problem with Tomassi's method is that Tomassi is silent on how to efficiently maintain data integrity and security when initially gathering an individual's data to create the identity cards, and the cards themselves impose limitations on the process.

Accordingly, a need exists for an enrollment method and vending mechanism that authenticates the identity of an individual attempting to use a vending machine to vend regulated or controlled products directly to customers without likelihood of abuse by underage or unauthorized users.

The applicant has discovered that an enrollment process in which a substantial amount of biometric data is conveniently obtained and efficiently stored and transported in a manner more suitable for ensuring that the identity authentication method really does control vending of the restricted or regulated product.

### OBJECTS AND SUMMARY OF THE INVENTION

Accordingly, it is a primary object of the present invention to overcome the above mentioned difficulties by providing a vending mechanism that authenticates the identity of an individual attempting to use a vending machine or the like to give access to regulated or controlled products or services.

Another object of the present invention is providing an enrollment method that efficiently collects and conveniently stores identity and biometric data for an individual intending to use a vending machine to vend regulated or controlled products or services.

The aforesaid objects are achieved individually and in combination, and it is not intended that the present invention be construed as requiring two or more of the objects to be combined.

The method of the present invention comprises two (2) primary steps: (1) Registration, a one-time procedure where a Patron's age is verified, fingerprint enrolled and information entered into an electronic tag, as well as a central database (if applicable); and 2) Purchase, which occurs each time a product or service is purchased, where the Patron presents the electronic tag to a tag reader (located on the front of the vending machine), authenticates his/her Identification by placing the appropriate finger onto a fingerprint scanner (also located on the front of the vending machine), then proceeds to purchase the product or service using cash, a credit card, or another payment method.

A more detailed outline of the procedure includes:

1. Registration Step (a one-time event for each Patron)
A. Age verification Step
   i. Driver's License or other State-approved Identification Card
   ii. Any other requirement dictated by State or Local authorities
B. Enrollment Step
   i. Addition of ID information into ID software (with optional extended database)
   ii. Scan personal biometric data (e.g., fingerprint template) into enrollment scanner
   iii. Encode ID information and fingerprint template onto electronic tag (note that fingerprint template is not stored centrally, but stored only on the tag)

2. Purchase Step(occurs each and every time product is purchased)
A. Authentication Step
   i. Electronic tag is placed onto the tag reader
   ii. Patron places finger onto fingerprint scanner
   iii. If scanned fingerprint matches fingerprint template stored on electronic tag, then enable customer to proceed with a purchase
B. Complete the Purchase Step
   i. Pay for the product, select
      a. Cash (coins, bills or combination of both)
      b. Credit card
      c. Debit function (from electronic tag information), or
      d. Other approved payment method
   ii. Press the selecting actuator or button for the desired product or service
   iii. Remove dispensed product or receive service and any change (if applicable).

In the enrollment phase, the customer or patron's identity and birth date are verified, using a method, e.g., as approved by the local authorities. There are two different options that can be utilized: central and stand-alone. These terms will be used throughout when the procedure varies slightly, due to differences in the authentication process used for each option.

Central means that a uniquely assigned identification or I.D. number is stored on the electronic tag, in addition to the fingerprint template, and that I.D. number is used to look up demographic information in an on-line central database, which will include, but not be limited to, the Patron's birth date. When the central method is being used, all decisions regarding purchase of the products are made at the central computer location, and may be based upon other factors in addition to the Patron's date of birth (e.g. is there enough credit on the account to allow a debit purchase, etc). In addition, if the vending machine is “off-line” with the central computer, a purchase cannot be made.

Stand-alone means that the date of birth is stored on the electronic tag, in addition to the fingerprint template, and that no other information identifying the Patron is stored on the tag. When the stand-alone method is used, the electronics inside the machine (controller board) make the decision for purchase, without consulting any other data than that which is read from the tag. The controller board simply reads the tag, transmits the information to the fingerprint scanner for verification, then if verification is positive, computes the difference between the date of birth and the date of purchase, then compares it with the acceptable age limit, which has been field-programmed. If the age of the Patron is at or above the field-programmed age limit, then the purchase is allowed to take place.

The enrollment procedure consists of a Patron placing his or her selected or pre-determined appendage, preferably a thumb or finger onto the fingerprint scanner, in order to collect the fingerprint image. The Patron may be required to place the same finger two or three times on the scanner, to allow the scanner to analyze multiple samples of the fingerprint. Once the scanner has satisfactorily collected the fingerprint image, it converts the image to a digital format, known as a template, which is then stored on the electronic tag.

Then, the enrollment person types in either the Patron's I.D. number (assigned by the central computer database software, in the case of a central-type system) or the Patron's date of birth (in the case of a stand-alone system). Whichever information is typed in by the enrollment person (I.D. number or Date of Birth) is stored onto the electronic tag, along with the Patron's fingerprint template. Once the transaction is complete, the fingerprint template is cleared from the enrollment station (i.e. only the electronic tag retains the fingerprint template information).

At this point, the enrollment procedure is finished for the Patron. If the system is a central-type system, then additional information may be needed to activate the electronic tag for purchase. But this additional information is installation-specific, does not involve the Patron, and therefore fall outside the scope of this document.

Authentication takes place as part of a Purchase transaction. The Patron approaches the vending machine, and (hopefully) notices the back-lit and flashing LCD display indicating that in order to make a purchase from this machine, he/she must touch an electronic tag to the tag reader, which is clearly labeled as such. Upon touching the tag reader with an enrolled tag, the controller board (EMRI-2A) reads the fingerprint template from the electronic tag, along with the I.D Number (if the system is a central-type) or the date of birth (if the system is stand-alone). The EMRI-2a is a controller board manufactured by Entry-Master Systems, Inc. of Baltimore Md.

The authentication system includes an enrollment station (for gathering patron identity information and selected additional patron information, including biometric information, and encoding portable data bearing records or fobs), an optional database storage facility (for storing all of the patron data) and at least one vending station (configured to decode the patron data on the fobs, detect or scan biometric data from a prospective purchaser using the fob and, if appropriate, enable completion of a vending transaction).

The above and still further objects, features and advantages of the present invention will become apparent upon consideration of the following detailed description of a specific embodiment thereof, particularly when taken in conjunction with the accompanying drawings, wherein like reference numerals in the various figures are utilized to designate like components.

### BRIEF DESCRIPTION OF THE DRAWINGS

FIG. 1 is a schematic diagram illustrating the authentication mechanism's enrollment station, in accordance with the present invention.

FIG. 2 is a block diagram illustrating an exemplary embodiment of the enrollment portion of the authentication method, in accordance with the present invention.

FIG. 3 is a schematic diagram illustrating the authentication mechanism's vending station, in accordance with the present invention.

FIG. 4 is a block diagram illustrating an exemplary embodiment of the vending portion of the authentication method, in accordance with the present invention.

### DESCRIPTION OF THE PREFERRED EMBODIMENT

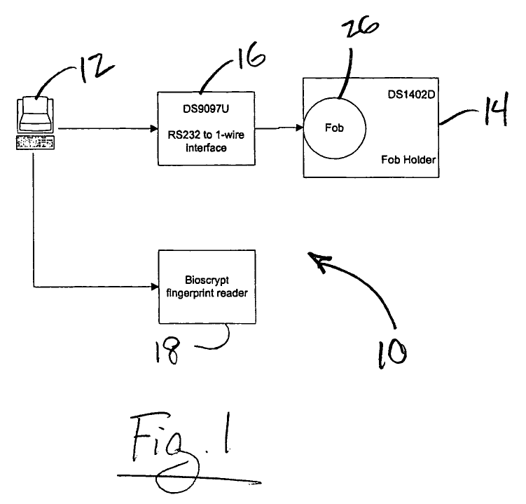

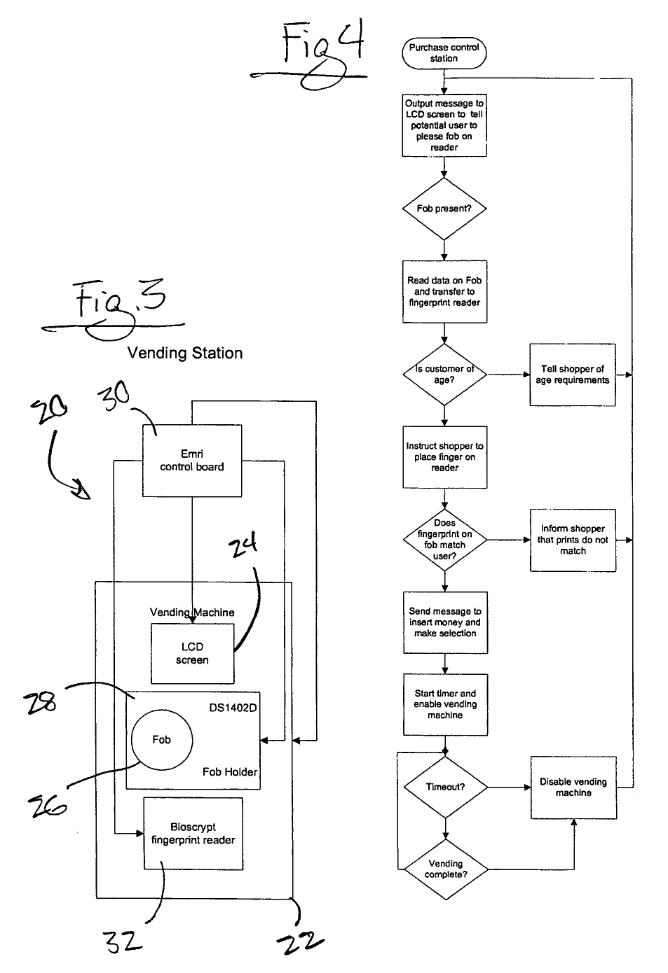

Referring now to FIGS. 1-4, in accordance with the present invention, an authentication system or mechanism includes an enrollment station 10, as best seen in the exemplary embodiment of FIG. 1 and a vending station 20, as best seen in the exemplary embodiment of FIG. 3.

The method or procedure of the present includes the following steps:

1. Registration (a one-time event for each Patron)
A. Age (or other qualification) verification
   i. Driver's License or other State-approved Identification Card
   ii. Any other requirement dictated by State or Local authorities
B. Enrollment
   i. Addition of ID information into ID software (with optional extended database)
   ii. Scan biometric data (e.g. fingerprint template) into enrollment scanner
   iii. Encode ID information and fingerprint template onto electronic tag (note that fingerprint template is not stored centrally, but stored only on the tag)

2. Purchase (occurs each and every time product or service is purchased)
A. Authentication
   i. Electronic tag is placed onto the tag reader
   ii. Patron places finger onto fingerprint scanner
   iii. If scanned fingerprint matches fingerprint template stored on electronic tag, then proceed to next step
B. Make the Purchase
   i. Pay for the product or service, selecting from among
      a. Cash (coins, bills or combination of both)
      b. Credit card
      c. Debit function (from electronic tag information) or
      d. Other approved payment method
   ii. Press the button for the desired product or service
   iii. Remove dispensed product or receive service

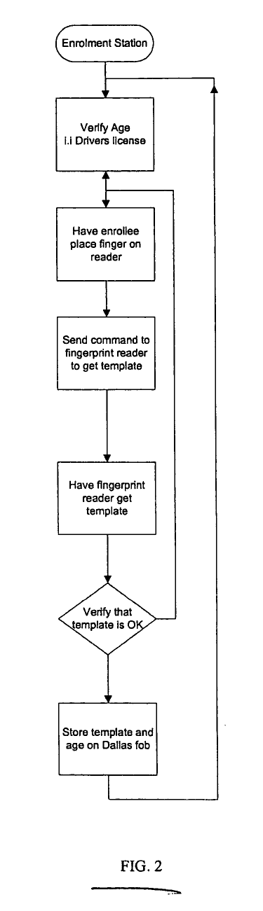

In the enrollment phase illustrated in FIG. 2, the Patron's identity and birth date are or have been verified using a method (e.g., as approved by the local authorities). There are two different options that can be utilized: central and stand-alone. As noted above, these terms will be used when the procedure varies slightly, due to differences in the authentication process used for each option.

For purposes of nomenclature, “Central” means that a uniquely assigned identification or I.D. number (or other unique, assigned indicia) is stored on a portable data bearing record (e.g., an electronic tag or fob), in addition to the fingerprint template, and that I.D. number is used to look up demographic information in an on-line central database, which will include, but not be limited to, the Patron's birth date. When the central method is being used, all decisions regarding purchase of the products are made at the central computer location, and may be based upon other factors in addition to the Patron's date of birth (e.g. is there enough credit on the account to allow a debit purchase, etc). In addition, if the vending machine is “off-line” with the central computer, a purchase cannot be made.

For purposes of nomenclature, “Stand-alone” means that the date of birth is stored on the electronic tag, in addition to the fingerprint template, and that no other information identifying the Patron is stored on the tag. When the stand-alone method is used, the electronics inside the machine (controller board) make the decision for purchase, without consulting any other data than that which is read from the tag. The controller board simply reads the tag, transmits the information to the fingerprint scanner for verification, then if verification is positive, computes the difference between the date of birth and the date of purchase, then compares it with the acceptable age limit, which has been field-programmed. If the age of the Patron is at or above the field-programmed age limit, then the purchase is allowed to take place.

The enrollment procedure (FIGS. 1 and 2) consists of a Patron placing his or her selected or pre-determined appendage, preferably a thumb or finger onto scanner 18, in order to collect the Patron's fingerprint image data. The Patron may be required to place the same finger two or three times on the scanner, to allow the scanner to analyze multiple samples of the fingerprint. Once the scanner has satisfactorily collected the fingerprint image, it converts the image to a digital format, known as a template, which is then stored on the electronic tag 26.

The enrollment person then types in either the Patron's I.D. number (assigned by the central computer database software, in the case of a central-type system) or the Patron's date of birth (in the case of a stand-alone system). Whichever information is typed in by the enrollment person (I.D. number or Date of Birth) is stored onto the electronic tag 26, along with the Patron's fingerprint template. Once the transaction is complete, the fingerprint template is cleared from the enrollment station 10 (i.e. only the electronic tag 26 retains the fingerprint template information).

At this point, the enrollment procedure is finished for the Patron. If the system is a central-type system, then additional information may be needed to activate the electronic tag for purchase. But this additional information is installation-specific, does not involve the Patron, and therefore fall outside the scope of this document.

Turning now to the authentication and vending steps illustrated in FIG. 4, authentication takes place as part of a Purchase transaction. The Patron approaches a vending machine 22, and (hopefully) notices the back-lit and flashing LCD display 24 indicating that in order to make a purchase from this machine, he/she must touch an electronic tag or fob 26 to the tag reader 28, which is clearly labeled as such. Upon touching or enabling the tag reader 28 with an enrolled tag 26, the controller board 30 (e.g., an Entry-Master Systems, Inc. model EMRI-2A) reads the fingerprint template from the electronic tag 26, along with the I.D Number (if the system is a central-type) or the date of birth (if the system is stand-alone).

The fingerprint template information is then sent via a data link (e.g., RS-232) to the fingerprint scanner 32. The controller board 30 then causes the LCD display 24 to direct the Patron to place the pre-determined thumb or finger on fingerprint scanner 32, which is also preferably clearly labeled.

The Patron then places the appropriate finger on scanner 32 and the scanner compares the scanned fingerprint image to the image stored within the template, provided by the controller board 30, which in turn reads the template information from the electronic tag 26. At this point, the controller board 30 waits for a response from the fingerprint scanner 32 (e.g., “Yes” to affirm a matched fingerprint or “No” to indicate that there is not a match).

If the match is unsuccessful, then the scanner 32 replies with a “No” to the controller 30, causing LCD display 24 to indicate that a match was not made, after which the LCD display returns to its original message, indicating that a tag must be presented in order to make a purchase.

If the fingerprint scan matches the template uploaded from electronic tag 26, then scanner 32 replies to the controller with a “Yes”, after which controller 30 compares the birth date read from the electronic tag (stand-alone) or sends the I.D. Number to the central computer for a decision (central-type).

If either method yields a positive result (i.e., indicating a purchase can be made) then the controller enables the vending machine's transactional apparatus by, for example, activating a VEND relay (for a field-programmable VEND time, a selected number of seconds) and causes LCD display 24 to indicate to the Patron that a purchase can be made. During this field-programmable VEND time, only ONE product or service can be purchased. The relay “drops out” (preventing further purchases) after a product or service is selected and dispensed, OR after the VEND time expires (i.e. no purchase is made). Once the VEND relay “drops out” (either by a product or service being purchased or by no purchase and the time expires) the LCD display reverts back to its original message, indicating that a tag must be presented in order to make a purchase.

Turning now to Programmable Parameters, this section lists the field-programmable parameters, which can be programmed into the controller unit. Note that most of these pertain to both the central-type and stand-alone versions of the product. Parameters that only pertain to the stand-alone version are marked with an asterisk (*).

A. Age limitation(*) to purchase alcohol (determined by State and local statute)

B. Template Tolerance for matching fingerprint templates (1%-99%)

C. VEND Timeout time allowed for a Patron to complete a purchase (in seconds)

D. Scan Timeout time allowed for the Patron to present a valid finger after reading a tag

In an illustrative embodiment, the electronic tag 26 or data bearing record is an iButton™ brand four kilobit (4-kbit) EEPROM, model number DS 1973, in the F5 microcan configuration as sold by Dallas Semiconductor. The electronic tag can be encoded or programmed by and then decoded or read through an iButton™ brand EEPROM reading probe, model number DS1402D0XX also by Dallas Semiconductor.

In the enrollment station 10, a computer terminal 12, as shown in FIG. 1, is preferably connected to a DS 1402D fob holder/encoder 14 via a one-wire com port adapter 16 such as a model number DS909U also by Dallas Semiconductor.

The patron's biometric data (e.g., fingerprint data) is collected via a sensor 18 such as those available from Bioscrypt, Inc. (e.g., a model MV 1200 fingerprint biometric reader and authentication engine configured with, for example, the BIO-SDK™ biometric reader/scanner software system). The biometric data scanner or detector 18 generates unique identifying biometric data for each patron and, in the system of the present invention, biometric data files on individuals whose fingerprints are scanned are analyzed, whereupon a data file is generated and can be stored, either on a portable data bearing record or in a central database.

It will be appreciated by those of skill in the art that the method and system of the present invention can be used for other applications, including verification that an identified individual should or should not receive or have access to almost any good or service. For example, the system and method of the present invention is readily adapted for use in automated procedures for registering firearms or controlling access to firearms, pharmaceuticals or any other good or service that is restricted or controlled in accordance with a system of laws or rules.

Broadly speaking, the present invention includes an authentication method for use in vending a restricted product or service, comprising (a) enrolling a patron or user by verifying the identity and selected data about the patron, including biometric data measured from the patron; (b)encoding the patron's identity and selected data including unique, assigned indicia, onto a portable data bearing record; (c) providing a vending or dispensation control apparatus (e.g., a vending machine) having a portable data bearing record reading device and a biometric data gathering instrument; (d) reading the patron's identity and selected data from the portable data bearing record utilizing the reading device in the vending machine when the portable data bearing record is placed on the reading device by a potential user; (e) scanning or detecting actual patron biometric data from the potential user using the vending machine's biometric data gathering instrument; (f) comparing scanned or detected actual biometric data of the potential user to the selected data contained on the portable data bearing record; and (g) enabling the vending machine to dispense the restricted product or provide the restricted service only if the scanned or detected biometric data from the potential user matches the selected data stored on the portable data bearing record.

The biometric data can be taken from any person's appendage or body part such as a thumbprint or fingerprint, and the selected patron data preferably includes age data indicating that the patron is older than a predetermined minimum age. This embodiment is useful when, for example, the product is an alcoholic beverage.

The authentication method can further comprise: (h) storing the patron's identity and selected data in a database; and (i) transmitting the patron's identity and selected data from the database to the vending machine.

Broadly speaking, the authentication system of the present invention is useful in automated granting of access to a restricted product or service and comprises: an enrollment station including a data terminal connected to a biometric data scanner and an encoder for programming a portable data bearing record with a patron's selected data, including the patron's biometric data and identification data; and a vending station configured to vend the restricted product or service including a biometric data scanner for generating a prospective user's biometric data file when a prospective user seeks to obtain the restricted product or service. The vending station also includes data input device configured to receive and decode data from the portable data bearing record, and a processor programmed to receive the prospective user's biometric data file and compare the prospective user's biometric data file to data stored on the portable data bearing record. The processor is further programmed to enable the vending station only in response to a match between selected data in the portable data bearing record and the prospective user's biometric data file.

Having described preferred embodiments of a new and improved method, it is believed that other modifications, variations and changes will be suggested to those skilled in the art in view of the teachings set forth herein. It is therefore to be understood that all such variations, modifications and changes are believed to fall within the scope of the present invention as set forth in the claims.

What is claimed is:

1. An authentication method for use in vending a restricted product or service, comprising:
(a) enrolling a patron, by verifying the identity and selected data about the patron, including biometric data measured from the patron;
(b) encoding said patron's identity and selected data including unique, assigned indicia, onto a portable data bearing record;
(c) providing a vending machine having a portable data bearing record reading device and a biometric data gathering instrument;
(d) reading said patron's identity and selected data from said portable data bearing record utilizing said reading device in said vending machine when said portable data bearing record is placed on said reading device by a potential user;
(e) scanning or detecting actual patron biometric data from the potential user using said vending machine's biometric data gathering instrument;
(f) comparing scanned or detected actual biometric data of the potential user to said selected data contained on said portable data bearing record; and
(g) enabling the vending machine to dispense the restricted product or provide the restricted service only if said scanned or detected biometric data from the potential user matches said selected data stored on said portable data bearing record.

2. The authentication method of claim 1, wherein said biometric data comprises a thumbprint or fingerprint.

3. The authentication method of claim 1, wherein said selected patron data includes age data indicating that the patron is older than a predetermined minimum age.

4. The authentication method of claim 3, wherein the product is an alcoholic beverage.

5. The authentication method of claim 1, further comprising:
(h) storing said patron's identity and selected data in a database; and
(i) transmitting said patron's identity and selected data from said database to said vending machine.

6. An authentication system for use in vending a restricted product or service, comprising:
an enrollment station including a data terminal connected to a biometric data scanner and an encoder for programming a portable data bearing record with a patron's selected data, including the patron's biometric data and identification data;
a vending station configured to vend the restricted product or service including a biometric data scanner for generating a prospective user's biometric data file when a prospective user seeks to obtain the restricted product or service;
said vending station also including data input device configured to receive and decode data from said portable data bearing record;
said vending station also including a processor programmed to receive the prospective user's biometric data file and compare said prospective user's biometric data file to data stored on said portable data bearing record;
wherein said processor is further programmed to enable said vending station only in response to a match between selected data in said portable data bearing record and said prospective user's biometric data file.
